(19) United States
(12) Patent Application Publication
(10) Pub. No.: US 2019/0303434 A1
(43) Pub. Date: Oct. 3, 2019

(54) Method And Device For Generating An Electronic Document Specification

(71) Applicant: OPEN AS APP GmbH, Munich (DE)

(72) Inventor: Stephan METHNER, Krailling (DE)

(21) Appl. No.: 16/307,416

(22) PCT Filed: May 26, 2017
(86) PCT No.: PCT/EP2017/062773

§ 371 Date: Dec. 5, 2018

(30) Foreign Application Priority Data
Jun. 7, 2016 (DE) 10 2016 110 513.9

(51) Int. Cl. G06F 17/24; G06F 16/93; G06F 16/28

(52) U.S. Cl. CPC G06F 17/246; G06F 16/285; G06F 16/93; G06F 17/248

(57) ABSTRACT

The invention relates to a computer-implemented method for generating an electronic document specification for structuring data from a given data-source comprising a plurality of elements. The method comprises at least the steps of clustering elements into information blocks according to a block-building criterion based on the data contained in and/or on the metadata associated to the elements of the data-source, storing the information defining each information block, for at least an information block and for each value of a first set, computing a probability for the value being associated to the information block, identifying the most probable value of the first block-metadatum set, associating a first block-metadatum to the information block, assigning the most probable value to a first value of the first block-metadatum, and storing the first value, and generating the electronic document specification for implementing the information block according to the first value.

The present invention is directed to the technical field of processing of data, in particular, processing of data for its visualization in a variety of platforms. More specifically, the present invention is directed to the generation of an electronic document specification (e.g. in the form of an XML document) based on information content in an n-dimensional data source. In particular, the electronic document specification may constitute a definition for visualizing complex, and potentially unstructured informational content from the data source on, for example, a mobile device.

In largely data driven environments, such as large operations, science, and the like, the handling of multidimensional data-sources and particularly very big data sets becomes increasingly more relevant. While such data-centric environments often produce and store very large data sets, analysis and in particular visualisation of information contained or even hidden in the data becomes increasingly more crucial.

Often, big data sets are so large or complex that they cannot be handled by traditional data processing applications. This becomes increasingly more pertinent if multi-dimensional data sets are concerned. Also, such data sets may often be changing in content such that a continuous analysis and visualisation of information contained in the data sets may be necessary.

For the purpose of the following description, to make it simpler for the reader to envision the concepts of the present invention, an exemplary data set having 2 dimensions, often also called a simple matrix, or matrix is chosen. The 2 dimensional implementation of the data set is merely chosen for the sake of simplicity in describing the present invention and its embodiments but the invention equally applies to data sets of higher dimensionality.

In such a matrix data is contained in a two-dimensional grid with rows and columns. The data is often not evenly distributed but may be arranged in clusters with empty elements, or cells, in between them. Thus, matrices are thus semi-structured 2-dimensional data-sources, which may contain several independent sets of data in the form of clustered information and which do not enforce a particular structure for arranging the data, however, may still have a structure. In particular, the location of the data in the matrix may be freely chosen, and have a specified format.

In addition to this, in some matrices, elements of the matrix may have assigned to them functional relations, in particular between the data inside them or between data clusters, metadata representing data management and visualization features, or the like. Moreover, in some matrices, the matrix may be used as a representation of a higher order dimensional data source. This way, some matrices may allow for handling (e.g. analysing, capturing, searching, sharing, storing, transferring, visualising, querying) big, potentially multidimensional data sets.

Although matrices may allow simplified handling or viewing of information content of big data sources, one may still be overwhelmed with the sheer amount of information presented and/or the functional relationships hidden in the matrix. The structure of the data in such matrix can be highly complex and not easily understandable. As a side aspect, given matrices are generally not suitable for use with mobile applications given the dimensions of the available display area, discerning relevant informational content from such matrices in a mobile environment is even harder if not impossible.

The prior art does not appear to provide suitable automatic methods for converting informational content in large multidimensional data sources into a form that would output the data in a highly structured way to allow improved handling thereof, potentially also in mobile environments. In particular, there is a problem in that known data mining techniques have only limited capability to recognize the way the data contained in the data source may be organised in, if, for example, such organization is in a certain yet undefined way. Mostly, such techniques work under the assumption that data is organised according to a given structure.

These constraints translate into a substantial limitation of known methods, reducing the power and the flexibility inherent to such methods for mining data and ultimately outputting information contained therein in a well graspable way, that would allow for efficient representation and manipulation of such data included in multidimensional data sources. This imposes also limitations on the availability of such information contained in multidimensional data sources for being output for use in mobile environments. In particular, any such output would not be available in an automatic manner that could even be invoked from within such a mobile environment.

It is therefore an object of the invention to provide an automatic method and apparatus for mining data sources, preferably multidimensional data sources for informational content and outputting such informational content in a highly structured manner.

This object is solved by a method according to claim 1, a device according to claim 13, and a computer-readable medium according to claim 14. Embodiments of the invention are subject matter of the respective dependent claims.

The present invention concerns a computer-implemented method for generating an electronic document specification for structuring data from a given n-dimensional data-source. The data-source comprises a plurality of elements in each dimension, the elements containing data and/or having metadata associated thereto. In particular, the elements of the n-dimensional data-source may be in a one-to-one correspondence with the values of an n-tuple of indices associated thereto. The n-tuple of indices may uniquely and unambiguously determine the position that the element associated thereto occupies in the data-source. Moreover, if e.g. the indices of said n-tuples are numbers, it is possible to define a metrics, e.g. a Euclidean metrics, allowing one to define the distance between the elements of the data-source.

The data-source may be an n-dimensional data-source, such as a database multidimensional database, or the like. The data-source may contain diverse types of structured, semi-structured, and/or unstructured data, in particular, data which may be subject to change in content and/or size.

The data collected in the element of the data-source and the possible metadata associated thereto are for instance stored in a storage device, such as the memory of a computer (in particular the computer on which the method is implemented and/or one or a plurality of the computers on which the method is implemented), a secondary storage device such as hard disks, optical discs (e.g. CD or DVD), flash memory (e.g. USB flash drives), floppy disks, standalone RAM disks, and the like. Moreover, the data-source may be stored according to a data storage model such as the Cloud storage or the Nearline storage model.

In particular, the method of the invention comprises the steps of:
Clustering elements into information blocks according to a given block-building criterion;
Storing the information defining at least one information block, in particular each information block;
For each value of a given first set of values, computing a probability for the value being associated to the information block by means of a given computational procedure associated to the value;
Identifying the most probable value of the first set according to a given identification criterion based on the probability for the values of the first set;
Associating a first block-metadatum to the information block, assigning the most probable value to a first value of the first block-metadatum associated to the information block, and storing the first value; and
Generating the electronic document specification comprising at least instructions for implementing the information block according to the first value.

In particular, an information block is a set of elements of the n-dimensional data-source and thus a subset of the n-dimensional data-source. Moreover, an information block may be a cluster of elements of the n-dimensional data-source.

The block-building criterion is based on at least the data contained in and/or on the metadata associated to, the elements of the data-source. The block-building criterion may be based on metadata comprising information on the data-type of the data contained in the elements of the data-source. Data-types are for example integer, Boolean, character, floating-point number, alphanumeric string, dynamically calculated data, and the like. Moreover, the block-building criterion may be based on metadata containing information on the format used to present and/or to group together the elements of the data-source. For example information on the format may be output definitions of the corresponding elements, such as, content colouring, font, font size and style, framing, and the like.

Further, the block-building criterion may be based on the position of one or more of the data-containing elements of the data-source and optionally on the relative position and/or the dimension and/or distance of the data-containing elements of the data-source with respect to each other.

The probability for each value of the first set is in particular the conditional probability for said value being associated to the information block, given at least a first part of the data contained in and/or of the metadata associated to the elements of the information block, wherein said first part depends in particular on said value. In particular, the probability depends on a set of input parameters, which ultimately depend on the first part of the data contained in and/or of the metadata associated to the elements of the information block. For example, the probability depends on at least the density of the data-containing elements inside the information block, on an estimate of the regularity of the distribution of the data-containing elements inside the information block, on the number of elements of the information block, and/or on the number of elements of the information block arranged along a given dimension of the n-dimensional data-source.

Moreover, the probability may depend at least on the presence in the information block of elements containing data of a given first data-type (e.g. dynamically calculated data), on the number of said elements, on the position that said elements occupy in the information block, and/or on the relative position that said the elements occupy with respect to each other. In particular the position of an element in the information block is uniquely determined by the n-tuple of indices associated to the element, i.e. by the position of the element in the n-dimensional data-source.

The computational procedure associated to each value of the first set is in particular a procedure that, given the value of the first set, allows for identifying the corresponding set of input parameters. Moreover, the computational procedure allows for unambiguously computing the probability for the value, given the actual value of said input parameters. For example, the probability may be computed by means of a given conditional probability distribution, i.e. the computational procedure may involve a given conditional probability distribution depending on the input parameters. In this case, the probability corresponds in particular to the value that said probability distribution assumes in correspondence to the actual value of the input parameters.

The given identification criterion may be based on the definition of probability and aims at selecting the most probable value of the first set. For example, if the probability is defined as a number between 0 and 1 where 0 indicates impossibility and 1 indicates certainty, the identification criterion identifies the most probable value of the first set with the value associated with the largest probability.

The association between the first block-metadatum and the information block may for example be implemented by creating a table having entries specifying the information block and the first value. This information may be added to the information defining the information block or be stored in a separate location elsewhere. Any structure or format may be used to associate the information block and the first value, insofar as the information can be reliably retrieved and interpreted correctly.

The information defining the information block, and/or the first value are in particular stored in a storage device. Moreover, they may be stored according to a data storage model such as the Cloud storage or the Nearline storage model. Also the electronic document specification may be stored, e.g. in a storage device. For example, said specification may be stored according to a data storage model such as the Cloud storage or the Nearline storage model.

At least part of the instructions for implementing the information block, in particular the electronic document specification, may be readable by a processor to generate an electronic representation of at least part of the information block, which may be a view of at least part of the information block, in particular of part of the data of the data-source. Said electronic representation allows for, amongst other purposes, visualizing at least part of the data of the information block, in particular at least part of the data, of the data-source, on various platforms. More specifically, the electronic document specification, in particular the instruction for implementing the information block, may contain tags for specifying the information block according the first value of the first block-metadatum associated thereto. Moreover, it may specify classes, subroutines, and/or functions implementing, at least in part, functionality, format and/or content of at least the information block, in particular of at least part of the data-source.

The method according to the present invention does not require the data of the elements of the data-source to be organised according to a given structure. In fact, starting from the data contained in and/or on the metadata associated to the elements of the data-source, the method is able to automatically cluster the elements of the data-source into information blocks by means of the block-building criterion. Moreover, the method makes use of the metadata associated to and/or the data contained in the data-source to support the implementation of the information block e.g. to help in the identification of the instructions, which appropriately implement the information block. In fact, the generation of the electronic document specification comprising said instructions depend on the first value of the first block-metadatum, which is the value of the first set with the highest probability of being associated to the information block. Said value is selected by using the first part of the data contained and/or of the metadata associated to the elements of the information block and is thus related to said metadata and/or said data, which ultimately support the implementation of the information block.

The electronic document specification may be used to implement at least the information block, in particular the entire data-source. According to the method of the present invention, a provided data-source can be analysed to identify patterns, relationships and structures which may not have been known or even intended. A user of the electronic representation of the electronic document specification may thus use easily and quickly identify these aspects with virtually any n-dimensional data-source, whether intended with a specific structure or not.

Furthermore, the electronic document specification can be generated regardless of the size, structure and complexity of the data-source, e.g. even if the data-source comprises big data sets. Such a data-source may contain information which is generally stored or presented so as to be poorly, if not at all, comprehensible. Yet the representation of the information block, in particular of part of the data-source created based on the electronic document specification can provide a comprehensible visualization of this information, even on a mobile device. The user can then take an informed decision which would otherwise not be possible without the use of the invention.

Finally, the identification of the most probable value of the first set is performed largely automatically, without any necessary human intervention and is based on computational procedures, which provide an objective, reproducible, and verifiable selection procedure.

Embodiments of the present invention make use of pattern recognition techniques, such as, for example, neuronal pattern recognition techniques involving neural algorithms, to discover patterns in the data-source which can identify one or more structures therein. This is particularly beneficial when working with big data sets, where only such computational solutions can be feasibly employed for analysis of the data.

In an embodiment of the present invention at least a value of the first set may comprise information about the structure of the information blocks associated thereto. For example, said value may comprise information indicating that the information blocks associated thereto are a text, a collection of structured data, a collection of unstructured data, or a computation transforming at least an input into at least an output.

In this case, the method according to the invention makes use of at least some of the metadata associated to and/or of the data contained in the data-source to infer the way the data contained in the information block are organised and to generate the electronic document specification comprising instructions for implementing the information block accordingly. This would ultimately improve the reliability of the electronic representation of the information block.

In particular, for at least a value of the first set the first part of the data contained in and/or of the metadata associated to the elements of the information block may be chosen by means of a machine learning algorithm, which allows for the improvement of the reliability of the computation of the probability for said value of the first set.

As generally known, machine learning deals in particular with algorithms by which computers can learn and make predictions on data based on sample inputs. These machine learning algorithms differ from fixed algorithms which perform strictly static instructions and act based on explicit programming. In most cases, machine learning is often more accurate than direct programming, as they are data driven and can be adapted through large amounts of data, in particular through big data sets, automatically.

In an embodiment of the present invention, the data contained in and/or the metadata associated to at least one element comprises information concerning dependencies between elements. The method further comprises the step of:
Deriving the type of dependency between elements according to a dependency criterion and choosing and storing a value of at least a dependency-type definition from a given set of dependency-type definitions.

Moreover, the instructions for implementing the information depend on the value of the dependency-type definition.

For example, if the data of a given element is dynamically computed starting from the data contained in an input element of the data source, the metadata associated to the given element may comprise information concerning the dependency of said given element on the input elements. Moreover, dependencies between elements of the data-source may comprise correlations between elements established e.g. by means of big data techniques.

This way, the method is able to properly handle data-source comprising a plurality of subsets of data, wherein said subsets are related and/or dependent to each other. Moreover, the instructions comprised in the electronic document specification allow for an implementation of the information block which takes into account said relations and/or dependencies.

In another embodiment of the present invention, the instructions for implementing at least the information block comprise at least instructions to retrieve and/or to modify the information stored in the data-source.

In this embodiment the data contained in the data-source do not have to be included in the electronic document specification, since they can be retrieved from the data-source. Therefore, this embodiment allows for reducing the size of the memory space required by the electronic document specification and thus for simplifying the memory management of the computer implementing the method. Moreover, the electronic document specification generated by this embodiment may improve the flexibility of the electronic representation of the information block, since the data contained in the information block may be modified by acting on the data-source directly, i.e. without having to modify the electronic document specification.

Further, the electronic representation of the information block generated according to the electronic document specification allows for synchronising the value of the data visualised by said representation with the value of the data contained in the data-source. This is particularly useful in the case of data-sources constantly changing in content and/or size, e.g. data sources comprising big data sets.

An embodiment of the method of present invention further comprises the steps of:
Determining whether the information block fulfils a given block-tagging criterion, and
If the information block fulfils the block-tagging criterion, associating a second block-metadatum to the information block, assigning a given block-tagging value to a second value of the second block-metadatum associated to the information block, and storing the second value.

If the second block-metadatum is associated to the information block, the instructions for implementing the information block depend on the second value.

The block-tagging criterion is based on at least the data contained in and/or on the metadata associated to the elements of at least a first subset of the information block. For example, the block-tagging criterion depends on the presence of metadata comprising at least annotations and optionally on the content of such annotations. The block-tagging criterion may also be based on the first value of the first block-metadatum associated to the information block. Moreover, the block-tagging criterion may be based on metadata comprising information on at least the data-type, and/or on at least the high-level data-type of the data contained in the elements associated to the metadata. High-level data types are for example percentage, value of a physical quantity, time, location information, and the like.

If the information block comprises elements containing numerical data, the block-tagging criterion may be based on the value of the numerical data contained in some of said elements. In particular, the block-tagging criterion may be based on the numerical interval spanned by the values of the numerical data contained in some of said elements.

This embodiment of the method allows for an improvement of the electronic representation of the information block. More specifically, the method makes use of the block-tagging criterion to check whether the information block can be further characterized by means of the second value of the second block-metadatum. The electronic document specification may depend on this value and ultimately properly takes account of the further characterization of the information block.

The block-tagging value may contain information about the type of the data contained in at least some of the elements of the information block associated thereto. For example, the block-tagging value may contain information indicating that the data contained in said elements are integer numbers, floating point numbers, percentage values, number expressing values and physical quantities, time and/or spatial location.

In this case, the method makes use of at least some of the metadata associated to and/or of the data contained in the elements of the data-source to infer the type of data contained in the information block and to generate the electronic document specification comprising instructions for implementing the information block accordingly. This would thus improve the reliability of the electronic representation of the information block.

An embodiment of the method according to the present invention, further comprises the steps of
Determining whether the information block fulfils a given semantic-tagging criterion, and
If the information block fulfils at least the given semantic-tagging criterion, associating a third block-metadatum to the information block, assigning a given semantic-tagging value to a third value of the third block-metadatum associated to the information block, and storing the third value.

If the third block-metadatum is associated to the information block, the instructions for implementing the information block depend at least on the third value. In particular, said value may at least partially determine the ways the electronic representation of the information block may be manipulated and/or the ways the data contained thereto may be visualised.

The given semantic-tagging criterion is based at least on the first value of the first block-metadatum associated to the information block and/or on the comparison of the information block with given information blocks with known semantic. Moreover, the block-semantic criterion may be based on the second value of the second block-metadatum associated to the information block.

The semantic-tagging value may comprise information about the semantic of the information block. For example, it may comprise information indicating that the information block is a list of numbers, strings, hashes, identifiers, spatial location information, or combinations thereof. For example, if the semantic-tagging value indicates that the information block is a list of strings, the electronic document specification may contain instructions implementing an operation that allows to select an element of the information block. Moreover, if the semantic-tagging value indicates that the information block is a list of location information, the electronic document specification may contain instructions implementing an operation that allows one to visualise the spatial location information in a map and/or to link them with coordinates.

The method makes use of the semantic-tagging criterion to check whether the information block can be further characterized in terms of its semantics by means of the semantic-tagging value assigned to the third value. The electronic document specification generated by the method contains instructions that depend on this value, which thus allows for improving the reliability and/or the functionality of the electronic representation of the information block.

Moreover, the third value, e.g. the semantic-tagging value assigned thereto, improves the functionality of the electronic representation of the information block by allowing for integrating the functionalities of other software into said electronic representation. For example, if the third value, e.g. the semantic-tagging value assigned thereto, comprises information indicating that the information block is a list of interfaces, the electronic document specification may contain instructions to link software implementing a list of interfaces. Moreover, if the third value, e.g. the semantic-tagging value semantic-tagging value assigned thereto, indicates that the information block is a list of numbers, the electronic document specification may contain instructions to link software that allows to select the number for further processing.

In yet another embodiment of the present invention, the instructions for implementing the information block, in particular the electronic document specification, are instructions readable by a mobile processor to generate a view of at least a second part of the data contained in the elements of the data-source.

In particular, at least the step of generating the electronic document specification may be implemented on a mobile processor, in particular on a device comprising a mobile processor.

In this case, the instructions for implementing the information block, in particular the electronic document specification, allows for implementing the information block in a way that is potentially also suitable for use with mobile applications. Therefore at least the second part of the data contained in the elements of the data-source, in particular the entire set of data contained in the data-source, can be output for use in constrained environments. Moreover, such output is available in an automatic manner that can be invoked from within such environment.

The electronic document specification may for instance create an electronic representation of at least the information block, in particular of at least part of the data-source, able to visualize the data of at least the information block, in particular of at least part of the data-source, on mobile devices. Functionality, format and/or content of at least the information block, in particular of at least part of the data-source can be at least partially reflected in the electronic representation via the electronic document specification.

In a further embodiment, the clustering of the elements into information blocks is obtained by performing either a divisive or an agglomerative hierarchical clustering analysis of the elements of the data-source, wherein said hierarchical clustering analysis builds a hierarchy among the information blocks.

In particular, hierarchical clustering is, as known in the art, a means for cluster analysis by classifying the clusters. The two main types of clustering are agglomerative and divisive clustering. In agglomerative clustering, the individual elements to be clustered start in a separate cluster, which are merged along the hierarchy. Divisive clustering in contrast starts with all elements in one cluster, and recursively split into smaller clusters along the hierarchy. In order to determine which clusters should be combined or split, a dissimilarity measure measuring the dissimilarity between sets of elements is required. In this case, the hierarchical clustering analysis, in particular the dissimilarity measure, may be based on the block-building criterion.

The appropriate hierarchical clustering analysis to be used is in particular dependent on the data and/or metadata of the elements of the data-source, in particular of the data-containing elements of the data-source, for example based on the aforementioned metric of the elements.

The hierarchical clustering is a well-defined, reliable, and verifiable analysis, which increases the reliability and/or the efficiency of the clustering of the elements of the data-source into information blocks. Hierarchical clustering may be particularly helpful for clustering data of data-sources comprising big data sets, in particular if the data of said data-source have been organised by means of big data techniques making use of hierarchical cluster analyses.

The choice of the value of the dependency-type definition may be based at least on the hierarchy among the information blocks. The hierarchy among the information blocks typically gives evidence on the relationships and/or on the dependencies between different information blocks. The hierarchy thus provides a useful pointer to an accurate dependency-type definition for the elements, since the dependency-type definition is closely tied to said relationships and/or to said dependencies.

In an exemplary embodiment of the invention, the method is further defined in that the probability for at least a value of the first set is computed by means of a given conditional probability distribution associated to the value, i.e. the computational procedure involves the conditional probability distribution. In particular, said probability distribution is a function depending on the input parameters associated to the value. In particular, the probability for the value corresponds to the value that the conditional probability distribution assumes in correspondence to the actual value of the input parameters.

Optionally, the conditional probability distribution associated to the value is computed by means of a machine learning algorithm and/or by means of a discriminative model, in particular logistic regression, applied to a sample of known data-sources. Known data-sources are e.g. data-sources comprising information blocks having the first block-metadatum associated thereto, wherein the value of said first block-metadatum is known.

A discriminative model is in particular a type of model used for modelling the dependence of a first variable, e.g. the probability for the value, on a set of variables, e.g. the input parameter associated to the value, by using a data sample, e.g. the sample of known data-sources. Discriminative models are particularly suited to be used in machine learning. In comparison to other machine learning models, such as generative models, discriminative models have the advantage of performing generally better in classification tasks.

Logistic regression is in particular a regression model to compute the conditional probability of a first variable, e.g. the probability for the value, on a set of variables, e.g. the input parameter associated to the value, by using a data sample, e.g. the sample of known data-sources, when the elements of the set of variables are categorical, i.e. can take a limited number of possible values.

The use of a conditional probability distribution allows for a conceptually simple and intuitive computational procedure. The implementation of said procedure can be simplified accordingly and can be designed to be maintained and/or modified relatively easily. For instance, if by means of a machine learning algorithm the conditional probability distribution is modified, the computational procedure may be easily modified accordingly, by simply acting on the implementation of the conditional probability distribution.

In a further embodiment of the present invention at least a part of the instructions for implementing the information block are obtained from an instructions template chosen from a set of templates. Moreover, the method further comprises the step of:
Choosing the instructions template from the set of templates according to a given template-selection criterion,

The given template-selection criterion is based at least on the first value of the first block-metadatum. Moreover, the template-selection criterion may be based on the second value of the second block-metadatum and/or on the third value of the third block-metadatum. Instructions templates provide a way to reuse instructions which have been previously created, which may be checked and ensured to be reliable, compliant and/or effective in use.

In another embodiment of the invention, the choice of the template according to the given template-selection criterion may be performed by means of a machine learning algorithm. The use of the machine learning algorithm allows for the improvement of the reliability and/or of the accuracy of the choice of the template, since the template-selection criterion can be adapted through large amounts of data automatically.

In a further example of the present invention, the given template-selection criterion is based on at least the value of the dependency-type definition. This improves the reliability of the electronic representation of the information block, since the relations and/or dependencies among the information blocks typically influence the functionality of the information blocks. It is thus advantageous to take account of these relations and/or these dependencies when choosing the instructions templates.

Another embodiment of the method of the present invention further comprises the step of:
Storing the information of the data contained in and/or of the metadata associated to the elements of the data-source in a database.

Moreover, the instructions for implementing the information block may comprise at least instructions to retrieve and/or to modify the information stored in the database. Depending on the data-source, the database may be a text database, desktop database, relational database, object-oriented database, cloud database, and the like. In particular, the database may be stored in a storage device.

This embodiment allows to not only view but also modify the data contained in the information block. Moreover, this embodiment allows for simplifying the memory management of the computer implementing the method, since typically the database requires less memory space than the data-source. In fact, the database does not have to store at least part of the information comprised in the metadata associated to the elements of the data-source, since said part of information is comprised in the block-metadata and is taken into account when generating the electronic document specification.

Further, advantages in storing the data contained in the data-source in the database include, amongst others, ease of access to data, numerous tools and functions available to be used for existing databases, and improved data security. Moreover, the data of data-sources comprising big data sets may be efficiently organised by means of efficient and publicly available platforms for data storage and query such as the High-Performance Computing Cluster (HPCC) System and the Quantcast File System (QFS).

In an exemplary embodiment of the invention, the method further comprises the step of:
Performing a hierarchical classification of the data contained in at least some of the elements of the information block according to a classification criterion based at least on the first value of the first block-metadatum.

Moreover, the instructions for implementing the information block generate a drilldown view of the data contained in the elements of the data-source according to the hierarchical classification of the data contained in at least some of the elements of the information block. Optionally, the hierarchical classification is performed by means of a machine learning algorithm.

If applicable, the classification criterion may be based on the second value of the second block-metadatum and/or on the third value of the third block-metadatum. If the information block is a computation, the method may allow for constructing a dependency graph for subsets of the information block and the classification criterion may be based on the result of an analysis of the dependency graph. Said analysis may for instance compute the number of the dependencies among subsets of the information block and/or categorize subsets of the information block e.g. by assessing whether they are inputs, outputs, or intermediate results.

Moreover, the classification criterion may be based on the result of a bag of words analysis of at least the data contained in the elements of a subset of the building block. Further, the classification criterion may be based on metadata comprising at least information on the modification history of the data contained in the element associated to the metadata.

The bag-of-words model is a known model typically used for classification methods. In this model, the multiplicity of the values of individual elements of a group is tracked. The multiplicity of the values is then used to evaluate the probability that the group belongs to one or more classes associated with the values. For example, the class associated to the value with the highest multiplicity could be assigned to the class of the group.

As used in information technology, the drilldown view is in particular a manner by which data can be traversed to different levels of the hierarchy to see information of that given level. Typically, traversing to a level below selected data will contain more specific information about the selected data.

For example, the view of a list shows only part of the data contained in the list, while the full data content of the list is displayed in a separate dialog window. Further, the view of a computation may show only the inputs and the outputs of a calculation, while the intermediate results may be displayed only upon further conditions.

The hierarchical classification of the data contained in the information block and the subsequent drilldown view of said data increases the usability of the electronic representation of the information block and/or of the electronic representation of the data-source. In particular, the relationship between the data contained in the information blocks, in particular in the entire data-source, can be easily tracked, recognized and manipulated. With the increased functionality of the data-sources (e.g. of the matrices), which can be handled by the method, in comparison to those generated by the prior art methods, these features provide a corresponding means in the electronic representation of the information block and/or of the electronic representation of the data-source for an orderly management and display of such functionality and of at least some of the data contained in the data-source.

In an embodiment of the invention, the method further contains the steps of:
Acquiring a first input value, wherein the first input value is one of the values of the first set;
Assigning the first input value to the first value of the first block-metadatum.

Moreover, in a further embodiment of the invention the values that the second block-metadatum may assume are comprised in a given second set of values and the method contains the steps of:
Acquiring a second input value, wherein the second input value is one of the values of the second set;
Associating the second block-metadatum to the information block, assigning the second input value to the second value of the block-metadatum, and storing the second value.

In another embodiment of the present invention, the values that the third block-metadatum may assume are comprised in a given third set and the method further contains the steps of:
Acquiring a third input value, wherein the third input value is one of the values of the third set;
Associating the third block-metadatum to the information block, assigning the third input value to the third value of the third block-metadatum, and storing the third value.

Further, an embodiment of the method of the present invention may contain the steps of:
Acquiring a dependency-type input value, wherein the dependency-type input value is one of the values of the set of dependency-type definitions;
Storing the dependency-type input value.

The first, the second, the third, and/or the dependency-type input value may, for instance, be acquired from a storage device and in particular they may be stored in a database and/or in a file. Further, they can be stored according to a data storage model such as the Cloud storage or the Nearline storage model.

The possibility to specify input values for the first, the second, the third block-metadata, and/or the dependency-type definition allows for increasing the customization possibilities of the method according to the present invention. In particular, this allows for optimising the design of the electronic representation of the information block e.g. to fulfil the requirements and the needs of the final representation.

In an exemplary embodiment of the invention, the instruction for implementing the information block are readable by a processor, in particular by a mobile processor and method further comprises the step of:
Generating an electronic representation of the information block according to at least the instructions for implementing the information block, in particular according to the electronic document specification.

Afterwards, said electronic representation may be stored e.g. in a storage device, in particular in a mobile device. Moreover, said electronic representation may be stored according to a data storage model such as the Cloud storage or the Nearline storage model.

In particular, the electronic representation of the information block reflects, at least in part, functionality, format and/or content of the data-source via the instructions for implementing the information block. Said representation of the information block may inter alia allow for visualizing the data of at least the information block, in particular of the entire data-source on various platforms.

At least a part of the instructions comprised in the electronic document specification may be written in a computer language, wherein the computer language is a markup, a scripting, a programming, and/or a style sheet language. Moreover, the computer language can be chosen from a list comprising at least XML, HTML, XHTML, CSS, SQL, Java, JavaScript, Python, Perl, C, C++, C Sharp (C#), Swift, Go, PHP, Ruby, and combinations thereof. Using computer languages, and particularly of these types, provides a flexible way for implementing the information block in a manner, which is appropriate for the chosen platform and suitable for the intended use of said implementation.

The present invention is also directed to a device configured for generating an electronic document specification, said device including storage means for storing at least one information block and associated block-metadata, and a processor connected to said storage means, said processor being programmed to implement the steps of the method according to any one of the embodiments described herein.

Additionally, the present invention is directed to a computer program product comprising instruction modules which, when executed by a processor of a computer, cause the computer to implement the steps of the method according to any one of the embodiments hereby described.

The device and the computer program product according the present invention implement the method according to the present invention, and thus inherit the aforementioned advantages of the method according to the present invention.

Exemplary embodiments of the invention are described in the following with respect to the attached figures. The figures and corresponding detailed description serve merely to provide a better understanding of the invention and do not constitute a limitation whatsoever of the scope of the invention as defined in the claims. In particular:

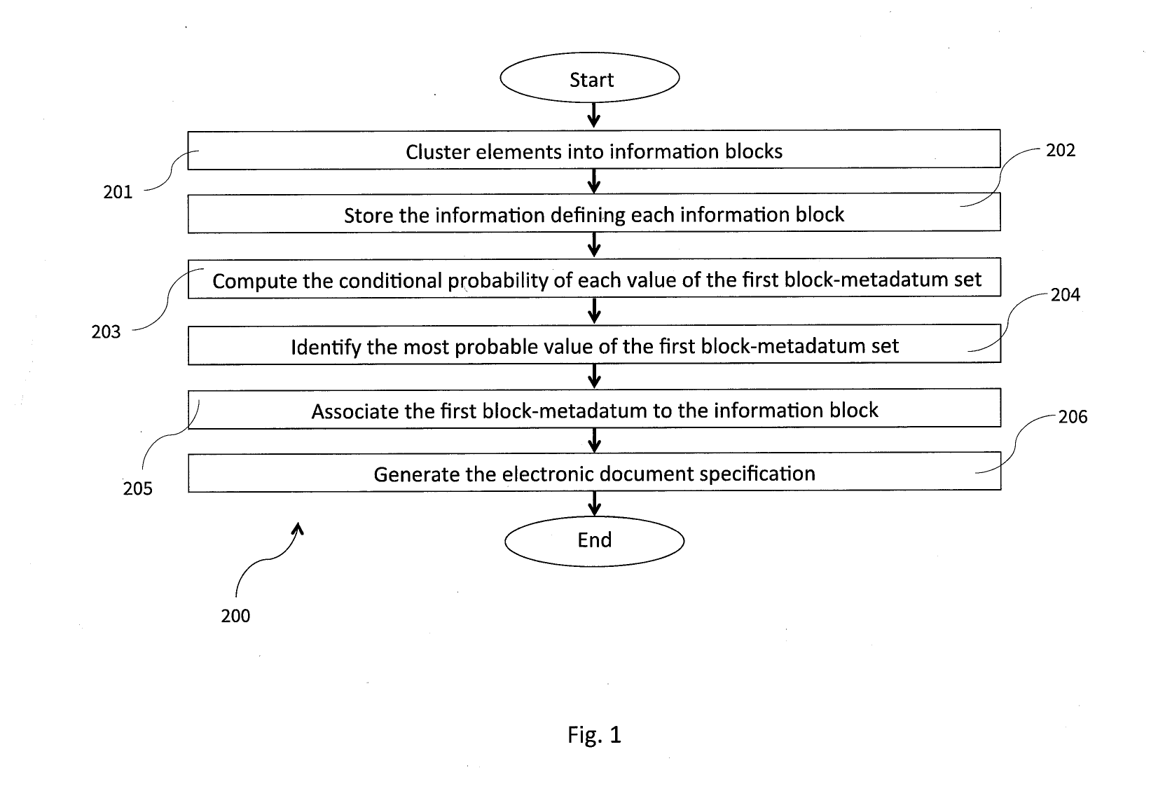

FIG. 1 is a flowchart 200 of a first embodiment of the method according to the present invention;

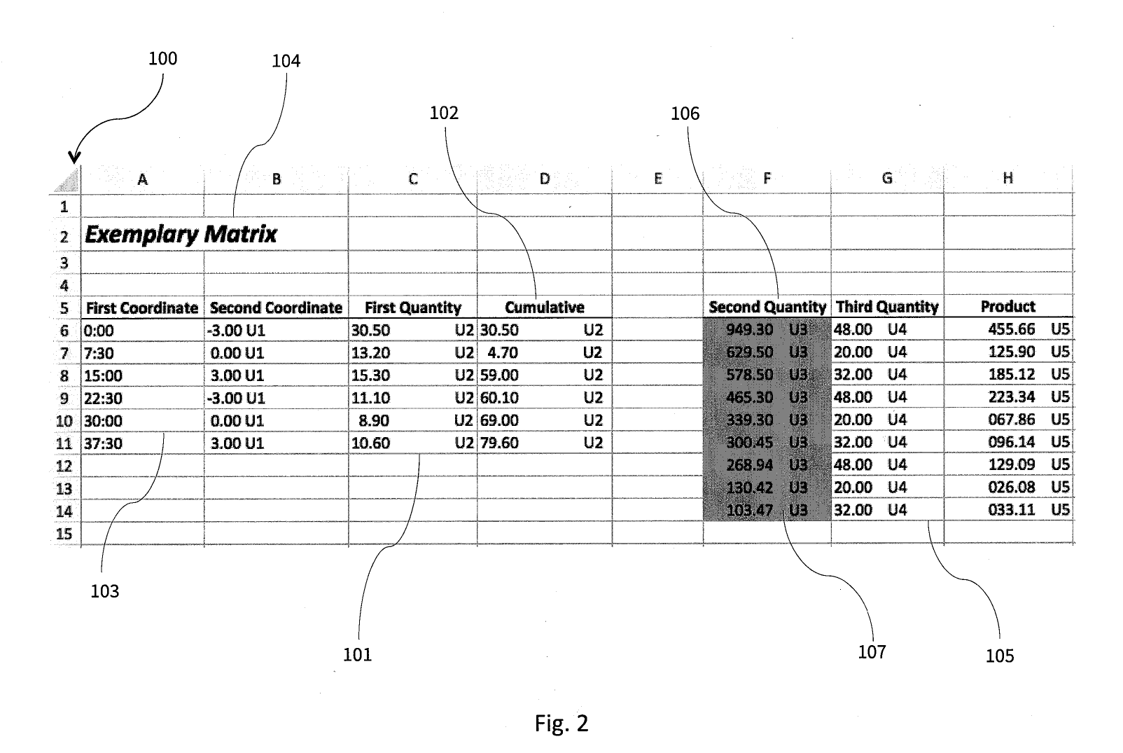

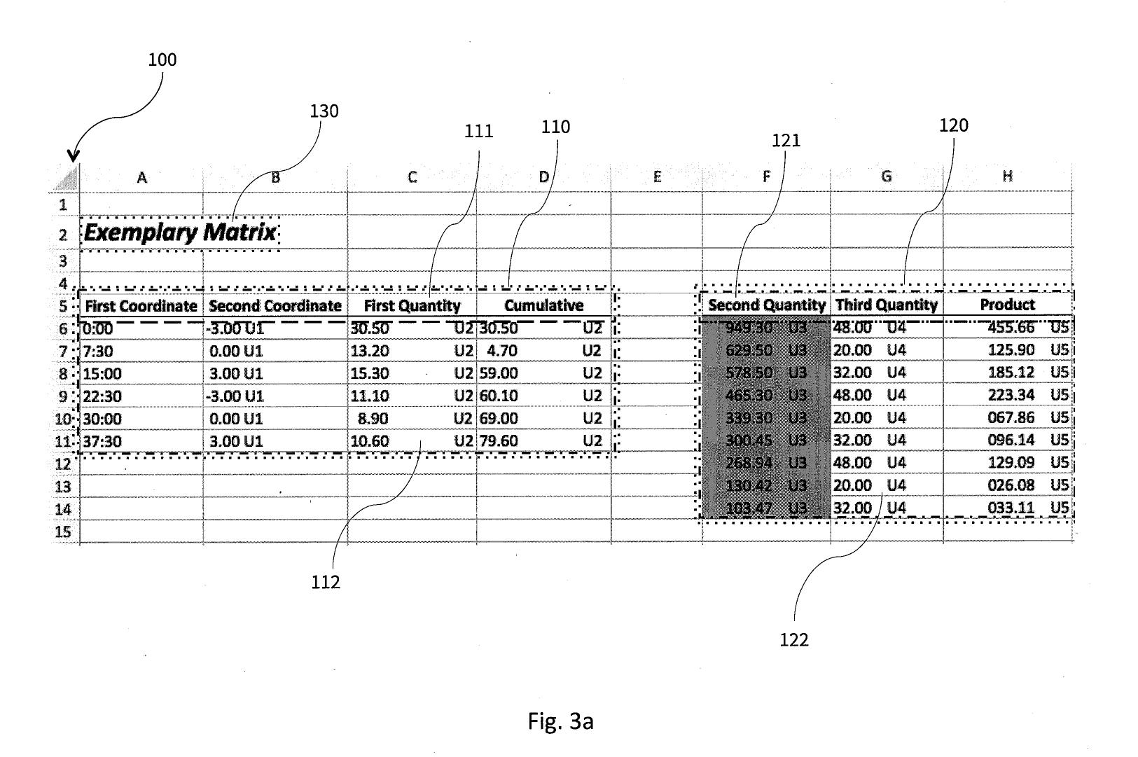

FIG. 2 is a sample matrix 100 which may be used in the first embodiment of the method according to the present invention;

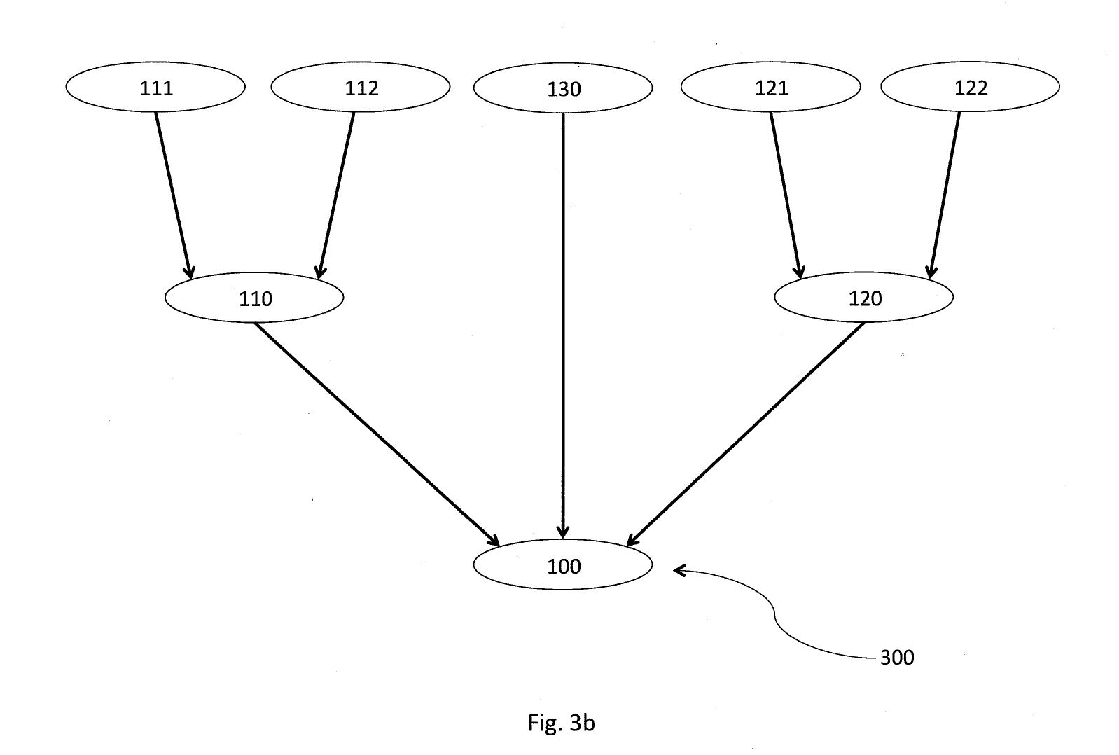

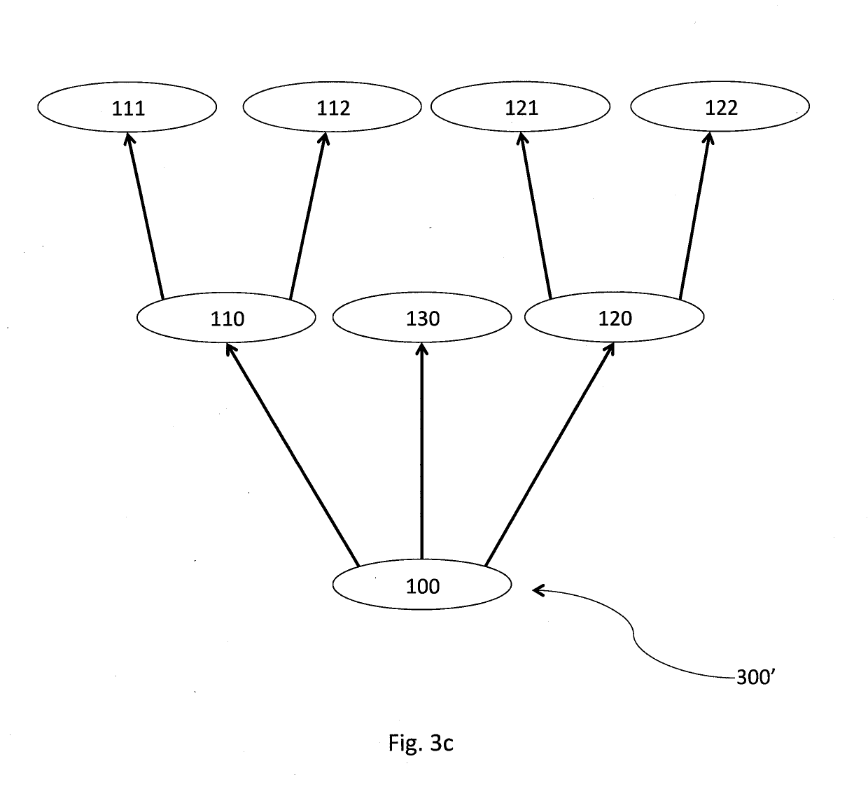

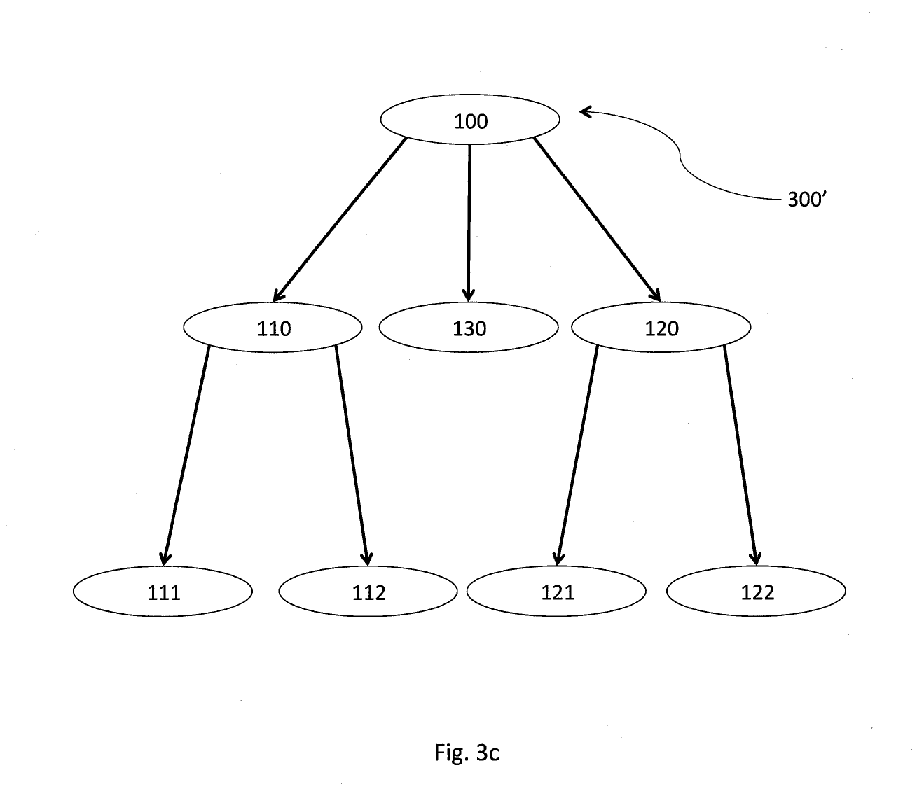

FIG. 3a is the sample matrix 100 of FIG. 2 wherein the elements of said matrix are clustered into information blocks by the first embodiment of the method according to the present invention;

FIG. 3b is a dendrogram 300 depicting the agglomerative hierarchical clustering of the elements of the sample matrix 100;

FIG. 3c is a dendrogram 310′ depicting the divisive hierarchical clustering of the elements of the sample matrix 100; and

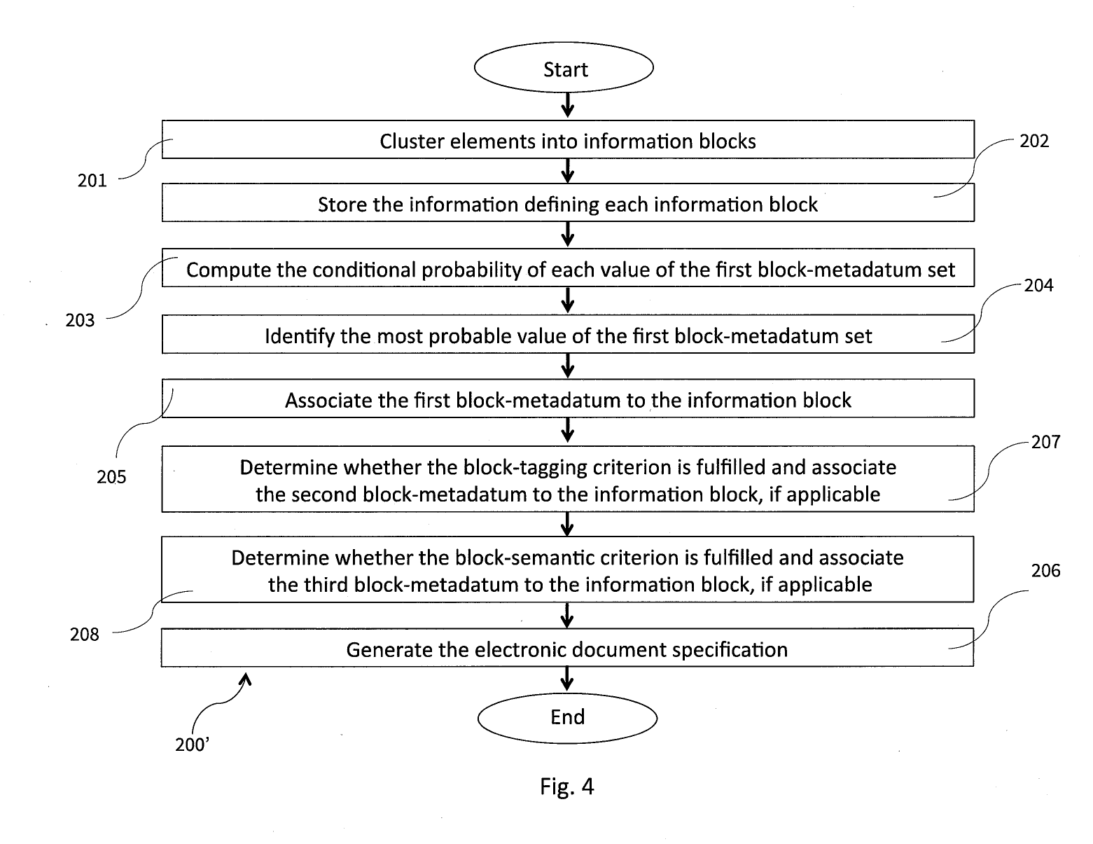

FIG. 4 is a flowchart 200′ of a second embodiment of the method according to the present invention.

FIG. 1 illustrates a flow chart 200 of a first embodiment of the method according to the present invention. This method generates the electronic document specification for structuring data from a given n-dimensional data-source, in this example a matrix. The electronic document specification may be an XML document, for example, which may be read by a processor, in particular by a mobile processor, to generate an electronic representation of the matrix. Said representation thus may reflect at least in part the functionality and/or data contained in the matrix.

The “Start” step indicates any necessary preparation work that may be involved before implementing the method of the present invention. This may include creating or selecting a matrix to be used for generating the electronic document specification. For example, a matrix may be uploaded to a storage device such as a server. Additionally, it is possible that only a portion of the matrix to be used in the method may be uploaded. Effectively, the selection determines what portions will be used for generating the electronic document and e.g. will be available in the electronic representation for display and manipulation. This may be useful if a large data-source is provided as input and e.g. different portions of the data-source are relevant. In this way, different electronic definition specification may be provided based on just a single data-source. Multiple data-source may also be used.

After the completion of the preparation work, the method performs the step of clustering the elements of the matrix into information blocks 201. The clustering is performed according to the block-building criterion, to partition the content into similar types. In the first embodiment of the method, the clustering may be performed according to an agglomerative or a distributive hierarchical clustering analysis detailed more specifically below with respect to FIG. 3b and FIG. 3c, respectively.

In a subsequent step, the information defining each information block is stored in order to retain said information 202. For example, the information may be stored on a storage device, in particular on the server where the matrix was uploaded. Moreover, the information may be stored in any suitable format, which e.g. can be interpreted to determine the correct information regarding the information blocks.

The information block must be assessed to determine what content they relate to. The method of the present invention assigns a first value of the first block-metadatum associated to the information block, which in particular indicates what content the block relates to. The possible values for the first block-metadatum are in particular those comprised in the first set. For instance, the first set may comprise at least the following values:
A first exemplary value comprising information indicating that the information block associated to said value is a text;
A second exemplary value comprising information indicating that the information block associated to said value is a collection of structured data;
A third exemplary value comprising information indicating that the information block associated to said value is a collection of unstructured data; and
A fourth exemplary value comprising information indicating that the information block associated to said value is a computation.

The method will seek to assign one of these values to the information block.

Hence, in the next step the probability is computed for this purpose 203. More specifically, the information block of the matrix is analysed and the probability for each value of the first set is computed automatically according to the computational procedure associated to that value.

The probability for the value is computed given the first part of the data contained in and/or of the metadata associated to the elements of the information block. For example, if many elements in the information block contain dynamically calculated data with reference to other elements of the matrix, a high probability will be given to the fourth exemplary value of the first set. If the content of many elements of adjacent rows in the information block have the same format (such as, e.g., integer, Boolean, character, floating-point number, alphanumeric string, dynamically calculated data, or the like) and this is applicable to adjacent columns, a high probability will be given to the second exemplary value.

Thereafter, the most probable value of the first set is identified 204. This identification is performed according to the identification criterion, which identifies the value with the highest probability in whichever form the computer system uses to compute the probabilities.

In particular, if the probability may be computed according to the widely accepted definition, i.e. the probability is defined as a number between 0 and 1 where 0 indicates impossibility and 1 indicates certainty, the identification criterion identifies the most probable value of the first set with the value associated with the largest probability. For example, if the probability of the first exemplary value is 0.1, the one of the second exemplary value is 0.6, the one of the third exemplary value is 0.35, and the one of the fourth exemplary value is 0.05, the highest probability is identified to belong to the second exemplary value, which thus is the most probable value of the first set. In particular, this implies that, according to the first embodiment of the method, the information block is a collection of structured data.

This leads to the step of associating the first block-metadatum to the information block, of assigning the most probable value to the first value, which is then stored 205. Similar to the matrix and/or to the information defining the information block, the first value may be stored on a storage device, in particular on the server where the matrix was uploaded, together with or separate to this data. Referring back to the second exemplary value having the highest probability, said value is thus assigned to the first value of the first block-metadatum

For example, the association of the first block-metadatum with the information block may be implemented by creating a table having entries specifying the information block and the first value. This information may be added to the information defining the information block or be stored in a separate location elsewhere. Any structure or format may be used to associate the information block and the first value of the first block-metadatum set, insofar as the information can be reliably retrieved and interpreted correctly.

In the next step 206, the electronic document specification is generated. The electronic document specification comprises at least instructions for implementing the information block according to at least the first value of the first block-metadatum. The instructions for implementing the information block are instructions readable by a mobile processor to generate a view of at least a second part of the data contained in the elements of the data-source.

As stated previously, the electronic document specification may be an XML document and it may contain tags for specifying the information block and the first value of the first block-metadatum associated thereto. In this way, for example, an electronic representation of at least part of the matrix may be created which is based on this XML document and which handles the information block appropriately.

For example, if the information block is associated to the second exemplary value, i.e. if the information block is a collection of structured data and specified as such in the XML document, the electronic representation created in accordance with the XML document will comprise a dropdown list for implementing the information block as a collection of structured data. Thus, functionality, format and content of the matrix can be accurately reflected in its electronic representation via the electronic document specification.

The “End” step may make appropriate use of the electronic document specification. In line with the examples above, this would be creating an electronic representation of the matrix based on the electronic document specification for, amongst other purposes, visualizing the data of the data-source on various platforms.

The fact that the electronic document specification can be generated by using the method of the present invention, which subsequently may be used to create an electronic representation of the matrix suitable for a variety of devices is beneficial for a number of reasons. In the method, a provided data-source can be analysed to identify patterns, relationships and structures which may not have been known or even intended. The method allows to easily and quickly identify these aspects with virtually any n-dimensional data-source, whether it is prepared with a specific structure or not.

Furthermore, the electronic document specification can be generated regardless of the size, structure and complexity of the data-source, e.g. big data sets. Such a data-source may contain information which is generally not comprehensible, or comprehended only to a limited extent, in the way it is stored or presented. Yet, the electronic representation of the matrix created based on the electronic document specification can provide a comprehensible visualization of this information, even on a mobile device.

FIG. 2 illustrates a sample matrix 100 that may be used as the data-source of the first embodiment of the method described in FIG. 1. The sample matrix 100 consists of a plurality of elements, each of which can be identified by the row and column indices. In this instance the elements are cells of the matrix 100, which will be used throughout the present example. The cells of the sample matrix 100, contain data and/or is associated to metadata. Furthermore, the row index is specified numerically and the column index is specified alphabetically and a cell will be denoted by the column index followed by the row index (e.g., A1 for the cell in the first column and the first row). By visual inspection, it is apparent that the sample matrix 100 includes three main portions: title 104, first table 101 and second table 105.

The first table 101 features a first header section 102 and a first body section 103. The first header section 102 specifies the type of content of the cells of the rows below it, which fall under the same column. For example, the header “First Coordinate” in cell A5 signifies the content of column A in rows 6 and onwards in the first table 101 to specify the numerical value of the first coordinate. The other headers of first header section 102 in first table 101 are “Second Coordinate”, “First Quantity” and “Cumulative”. The first body section 103 comprises the entry records of table 101. One entry record of table 101 includes a cell for each of the aforementioned headers. For instance, the entry record of row 6 of the first table 101 specifies a value of the first coordinate of “00:00”, a value of the second coordinate of −3 expressed in American numbering format with two decimal digits and in the unit of measure U1, a value of the first quantity of 30.50 and a cumulative value of 30.50, wherein the value of the first quantity and the cumulative value are expressed in American format with two decimal digits and in the unit of measure U2.

For example, each row of the first table 100 may be associated to a cell of a calorimeter of a particle detector as used in Physics. The first coordinate may be the azimuthal coordinate (expressed in degrees:minutes) of the cell while the second coordinate may be the axial coordinate (expressed e.g. in a length unit such as meter) of said cell. The first quantity may thus be the transverse energy measured by the cell and expressed in an energy unit such as joule or electronvolt. For a given row, the last column is the cumulative value of the transverse energy, obtained by summing the value of the transverse energy measured by the cell associated to the given row with the value of the transverse energy measured by the cell associated to the rows above the given one. For instance, the value in cell D8 is the sum of the values in the cells C8, C7, and C6.

The second table 105 is similar to the first table 101 in that it also features a second header section 106 and a second body section 107. The description of the structure of the first table 101 applies to the second table 105 as well, with the exception of the specific content provided therein. For instance, the second header section 106 includes the headers “Second Quantity”, “Third Quantity” and “Product”. The numbers of the second table 105 are specified in the American numbering format with two decimal digits.

For example, the second table 105 may collect the production and the decay channels of a given elementary particle at a given particle accelerator. In this case, each row of the second table 105 may be associated to a production and a decay channel of said particle. The second quantity may thus be the cross section (expressed e.g. in barns, in multiples or in sub-multiples thereof) of the production channel, while the third quantity may be the branching ratio (in percent) of the decay channel. Consequently, the last column is the product between the branching ratio and the cross section, which is a relevant quantity in high energy Physics.

In the sample matrix 100, each of the first table 101 and the second table 105 includes static cells and dynamically modified cells. Static cells are cells including data which are directly specified. An example is shown in cell F7 which contains the number 629,00 expressed in the unit of measure U3. Dynamically modified cells are cells containing data which are not directly specified but depend on the values of other cells in the matrix. A common example is an equation or function. As shown in cell H7, a number expressed in the unit of measure U5 (125,90) is given which is obtained by multiplying the value of the third quantity specified in cell G7 (20,00) expressed in the unit of measure U4 with the value of the second quantity specified in the unit of measure U3 in cell F7 (629,50), and by dividing by 100. The cells may also have other types of behaviour for the contained data, such as a reference to a webpage or an image.

Metadata may be associated to the cells of the matrix 100. For instance, the data contained in the cell B6 is the number “−3” and the metadata associated to the cell A6 includes information about the format type specifying a number with two decimal digits expressed in American numbering format. It can be appreciated that the metadata may comprise various information, for example about the colour (see e.g. cell F10) and the alignment of the content of the cell (see e.g. cell G11 and cell H8 wherein the data are left-aligned and right-aligned, respectively).

The units of measure U1, U2, U3, U4, U5 may be physical units of measure such as the units of measure of the International System of Units, multiples, or sub-multiples thereof. Moreover, they can also be arbitrary units such as units of account.

As explained in the first embodiment with respect to FIG. 1, the cells of the matrix are clustered into information blocks. FIG. 3a depicts how the sample matrix 100 may be clustered into the information blocks 110-112, 120-122, 130 according to the block-building criterion of the present invention. In FIG. 3a, the information blocks 110-112, 120-122, 130 are outlined by dotted or dash-dotted lines for illustrative purposes. According to the present invention, the information blocks 110-112, 120-122, 130 may be specified in terms of the stored information defining the information blocks and do not have to be visually marked in the sample matrix 100 itself.

The method of the present invention is able to automatically perform the clustering step 201 on the sample matrix 100 by identifying and using at least part of the data contained in and/or at least part of the metadata associated to the cells of the sample matrix 100. In particular, said parts are used to grasp the structure of the sample matrix 100.

In FIG. 3a, the data contained in the cell A2 is identified according to the block-building criterion to be independent from the content of the other portions of the sample matrix 100. The data contained in and/or the metadata associated to cell A2 in comparison to the information of the other cells do not reveal significant similarities. For example, the metadata comprises information about the font type and the font size associated to cell A2 is recognized according to the block-building criterion to differ from the information comprised in the metadata associated to the other cells. Moreover, the cell A2 is surrounded by cells not containing data and the cell A2 is not used in any calculations in the sample matrix 100. Accordingly, the information block 130 is recognized and clustered, which in fact corresponds to the title 104 as described in FIG. 2. Any number of these comparisons to cluster the cells of the sample matrix 100 may be specified according to the block-building criterion.

The block-building criterion may be based on the position of the cells in the matrix, and in particular on the position of the cells with respect to each other. For instance the data-containing cells from rows 5 to 11 at columns A to D form a 7×4 first set of cells (row by column). The cells from rows 5 to 14 at columns F to H form a 10×3 second set of cells (row by column), wherein the first and the second set of cells are separated from each other and from other portions of the sample matrix 100 having data-containing cells. According to the block-building criterion, the difference in dimensions provides an indication that the two sets of cells may not belong to the same information block. The block-building criterion, however allows for clustering the first set of cells to form information block 110 and the second set of cells to form information block 120. Therefore, each of the information blocks 110 and 120 are recognized and clustered, which in fact correspond to the first table 101 and the second table 105, respectively (see FIG. 2).

According to the block-building criterion, common features are identified in row 5 (cells of A5 to D5) which e.g. are not present in rows 6 to 11. In particular, the data contained in these cells are alphanumeric and the metadata associated to these cells comprise information about the display format, in this case the font being bold and data centre-aligned. Further, each of these cells belongs in the same row and located in consecutive columns of the sample matrix 100. Consequently, the information block 111 can be recognized and clustered according to the block-building criterion. Information block 111 corresponds to the first header section 102 as described in FIG. 2.

Regarding some of the cells of each of row 6 to row 11 of the sample matrix 100, a pattern is also identified. In the A, B, C, and D columns of each row the data contained in the cell are numbers and the metadata comprises information about the format of the data in the cell. Consequently, the information block 112 can be recognized and clustered according to the block-building criterion. Information block 112 corresponds to the first body section 103 in FIG. 2.

In the same manner, common features are recognized in some of the cells in row 5 and in rows 6 to 14 of the sample matrix 100, forming information blocks 121 and 122, respectively. Information blocks 121 and 122 correspond to second header section 106 and second body section 107, respectively (see FIG. 2).

Accordingly, information is created to define:
Information block 110 as comprising the cells of rows 5 to 11 at columns A to D;
Information block 120 as comprising the cells of rows 5 to 14 at columns F to H;
Information block 130 as comprising cell A2;
Information block 111 as comprising the cells A5 to D5;
Information block 112 as comprising the cells of rows 6 to 11 at columns A to D;
Information block 121 as comprising the cells F5 to H5, and
Information block 122 as comprising the cells of rows 6 to 14 at columns F to H.

The information defining each of the information blocks 110, 111, 112, 120, 121, 122, and 130 are stored appropriately as mentioned in the step 202 of the first embodiment of the method of the present invention.

Although in the description above the recognition and the analysis of the information blocks 110, 111, 112, 120, 121, 122, and 130 is presented according to a specific presentation order, such an order is not required in the method of the present invention. Any of the information blocks 110, 111, 112, 120, 121, 122, and 130 could be recognized and analysed in any particular order or even substantially at the same time.

An automatic mechanism by which the cells of the sample matrix 100 can be clustered is provided according to the block-building criterion. Said clustering may be achieved by performing a hierarchical clustering analysis. The hierarchical clustering analysis could be agglomerative (by building up clusters from individual elements) or divisive (by dividing a single cluster of all elements into clusters of subset of the elements). These types of hierarchical clustering analyses are shown in FIG. 3b and FIG. 3c, respectively. Other clustering methods are also envisioned to be applicable in the present invention.

FIG. 3b shows a tree diagram 300, more specifically a dendrogram, depicting the agglomerative hierarchical clustering analysis, while FIG. 3c depicts a dendrogram 300′ representing the divisive hierarchical clustering analysis. In particular said analyses are performed by the first embodiment of the method on the sample matrix 100 and allow for clustering the information blocks 110, 111, 112, 120, 121, 122, and 130 shown in FIG. 3a.

In the dendrograms depicted in FIG. 3b and FIG. 3c, each of the sample matrix 100 and the information blocks 110, 111, 112, 120, 121, 122, and 130 are represented by an individual node. In each of the two dendrograms, the arrows represent the clustering that is performed between the information blocks and show the direction in which the corresponding hierarchical clustering analyses is performed.

The agglomerative clustering analysis starts with a plurality of starting clusters. In the present example, the starting clusters are the information blocks 111, 112, 121, 122, 130, as shown in the top level of the dendrogram of FIG. 3b. The relationship between the information blocks 111, 112, 121, 122, 130 is assessed according to the block-building criterion to determine whether a bigger cluster comprising two or more of the information blocks 111, 112, 121, 122, 130 is possible. A relationship between information blocks 111, 112 based on the positioning and dimensions of the information blocks is recognized according to the block-building criterion. Other data contained in and/or metadata associated to the cells of the information blocks 111 and 112 may be additionally and/or alternatively used as a basis for the recognition. As shown in the middle level of the dendrogram, in FIG. 3b, the information blocks 111, 112 are clustered into information block 110.

A similar approach is taken and performed by the block-building criterion to recognize and cluster information blocks 121, 122 into information block 120.

At this stage, no further relationships are recognized between information blocks 110, 120 and 130, except that all of the information blocks belong on the sample matrix 100. Only an information block representing the sample matrix 100 can be recognized according to the block-building criterion. The information blocks 110, 120, 130 are thus clustered to form the information block representing the sample matrix 100, as shown in the bottom level of the dendrogram of FIG. 3b. The entire sample matrix 100 may be recognized as a single cluster.

Although the present example has depicted the information blocks 110, 120, 130 being clustered to form information block representing the sample matrix 100, further intermediate clustering may also be possible. For example, the information blocks 110, 120 may first be clustered, which is then subsequently clustered with information block 130. The particular manner in which the information blocks are clustered can be specified in the block-building criterion and can be adjusted accordingly.

While the starting clusters have been shown in this example as information blocks 111, 112, 121, 122, 130, it can be appreciated that the block-building criterion may typically start with individual cells, in particular the individual data-containing cells, of the sample matrix 100. The starting information blocks 111, 112, 121, 122 may be clustered according to the block-building criterion starting from the individual cells of the sample matrix 100 in the same manner as discussed to form information blocks 110 and 120. The starting point of information blocks 111, 112, 121, 122 is given in this example for ease and brevity of explanation.

Additionally, although the information blocks 110 and 120 are clustered from information blocks 111, 112 and information blocks 121, 122, respectively, which are adjacent to one another, the present invention is not limited in this manner. Information blocks which are separated may be clustered according to the block-building criterion and may not necessarily match in dimension or position, as in the given example of FIG. 3b. The clustering of information blocks depends on whether the block-building criterion is fulfilled and may or may not have a basis on the position, on the dimension and/or on distance of the information blocks and/or of the cells of the information blocks to be clustered. For example, the block-building criterion may be based on metadata associated to the cells of the matrix 100, wherein said metadata comprise information on the data-type (e.g. integer, Boolean, character, floating-point number, alphanumeric string, dynamically calculated data, et cetera) of the data contained in the cells of the sample matrix 100. Further, said metadata may contain information on the format (e.g. the colour, the font size, the font style, the presence of frames, et cetera) used to present and/or to group together the cells of the sample matrix 100.

The divisive hierarchical clustering analysis starts with a single starting cluster. In the present example, the starting cluster is the sample matrix 100, which can be considered an information block and is shown in the top level of the dendrogram of FIG. 3c. An assessment of whether one or more smaller clusters comprising one or more individual cells of the sample matrix 100 are possible is performed according to the block-building criterion. The tables 101, 105 and title 104 of the sample matrix 100 are recognized according to the block-building criterion in the manner previously discussed with respect to FIG. 3a. Data contained in and/or metadata associated to the cells of the information blocks 110, 120, 130 may be used as a basis for the recognition. As shown in the middle level of the dendrogram in FIG. 3b, the information block of sample matrix 100 is divided into information blocks 110, 120, 130.

A similar approach is taken and performed by the block-building criterion to recognize and divide information block 110 into information blocks 111, 112 and divide information block 120 into information blocks 121, 122.

Information block 130 is recognized according to the block-building criterion to be a single cell of the sample matrix 100 and cannot be divided further.

It can be appreciated that the information blocks 111, 112, 121, 122 may be divided further according to the block-building criterion. For example, the block-building criterion may identify that each row of information block 112 comprises essentially the same pattern. Each row may thus be recognized and clustered as an information block according the block-building criterion. Each such information blocks would represent a record entry of the first table 101 as shown in FIG. 2. The end point of information blocks 111, 112, 121, 122 is given in this example for ease and brevity of explanation.

FIG. 4 illustrates a flow chart 200′ of a second embodiment of the method according to the present invention. This embodiment, as the first embodiment, generates the electronic document specification for structuring data from a given n-dimensional data-source, in this example a matrix. The electronic document specification may be an XML document, for example.

The flow chart 200′ includes all of the steps 201 to 206, in addition to new steps 207 and 208. Steps 201 to 206 remain the same as in FIG. 1 and thus the discussion of the features of the first embodiment of the method with respect to FIG. 1 apply equally to the second embodiment.

In the second embodiment, the method further includes the step of determining whether the information block fulfils the given block-tagging criterion, and, if the information block fulfils the block-tagging criterion, the step of associating the second block-metadatum to the information block. The block-tagging value is assigned to the second value of the second block-metadatum, which is then stored. If the second block-metadatum is associated to the information block, the instructions for implementing the information block depend on the second value of the second block-metadatum.

The block-tagging value may contain information about the type of the data contained in at least some of the elements of the information block. For example, the block-tagging value may contain information indicating that the data contained in said elements of the information block are integer numbers, percentage values, values of a physical quantity, time, and/or spatial location information.

In particular, the block-tagging value provides further information about behaviour, requirements or other properties of the information block, which is not encompassed by the first value of the first block-metadatum. This further information can then be used to generate the electronic document specification for implementing the information block.

The given block-tagging criterion is based on at least the data contained in and/or on the metadata associated to the cell of at least the first subset of the information block. For example, the block-tagging criterion depends on the presence of metadata comprising at least annotations and optionally on the content of such annotations. The block-tagging criterion may also be based on the first value of the first block-metadatum associated to the information block.

Moreover, the block-tagging criterion may be based on metadata comprising information on at least the data-type, and/or on at least the high-level data-type (e.g. percentage, value of a physical quantity, time, location information, et cetera) of the data contained in the cell associated to the metadata.

If the information block comprises cells containing numerical data, the block-tagging criterion may be based on the value of the numerical data contained in some of said cells. In particular, the block-tagging criterion may be based on the numerical interval spanned by the values of the numerical data contained in some of said cells. For example, the block-tagging criterion may request the presence in the information block of a collection of possibly adjacent cells containing numerical data with two decimal digits, wherein the integer and the fractional part spans an interval from 0 to 360 and from 0 to 60, respectively. In this case, the block-tagging value may contain information indicating that the data contained in said elements of the information block are angular values expressed in the format “degrees.minutes”.

Although the step described above 207 is depicted in FIG. 4 immediately after step 205, it does not necessarily have to be performed after step 205. In particular, these steps can be performed in any particular order or even substantially at the same time.

The second embodiment of the method, further comprises the steps of determining whether the information block fulfils the semantic-tagging criterion, and, if the information block fulfils the semantic-tagging criterion, the step of associating the third block-metadatum to the information block 208. The semantic-tagging value is assigned to the third value of the third block-metadatum, which is then stored. If the third block-metadatum is associated to the information block, the instructions for implementing the information block depend at least on the third value of the third block-metadatum.

The given semantic-tagging criterion is based at least on the first value of the first block-metadatum associated to the information block and/or on the comparison of the information block with given information blocks with known semantic. The block-semantic criterion may also be based on the second value of the second block-metadatum.

The semantic-tagging value may comprise information about the semantic of the information block associated. For example, it may comprise information indicating that the information block is a list of numbers, a list of locations, a collection of numbers or hashes, or the like.

In particular, the semantic-tagging value provides further information about the semantic of the information block, which is not encompassed by the first value and/or by the second value. This further information can then be used to generate the electronic document specification for implementing the information block.

For example, if the semantic-tagging value indicates that the information block is a list of numbers, the electronic document specification may contain instructions implementing an operation allowing to select an element of the information block for further processing. Moreover, if the semantic-tagging value indicates that the information block is a list of locations, the electronic document specification may contain instructions implementing an operation that allows one to visualise such spatial location information in a map and/or link to them with the coordinates.

Moreover, the semantic-tagging value improves the functionality of the electronic representation of the information block by allowing the integration of functionalities of other software into said representation. For example, if the semantic-tagging value comprises information indicating that the information block is a list of interfaces, the electronic document specification may contain instructions to link software implementing a list of interfaces.

Step 208 as shown in FIG. 4 is performed in the method following step 207, but is not limited in this manner. In particular, these steps can be performed in any particular order or even substantially at the same time.

1. Computer-implemented method for generating an electronic document specification for structuring data from a given n-dimensional data-source, wherein the data-source comprises a plurality of elements in each dimension, the elements containing data and/or having metadata associated thereto, said method comprising the steps of:
clustering elements into information blocks according to a given block-building criterion, wherein the block-building is based on at least the data contained in and/or on the metadata associated to the elements of the data-source;
storing the information defining at least one information block;
for each value of a given first set of values, computing a probability for the value being associated to the information block by means of a given computational procedure associated to the value, wherein the probability is the conditional probability given at least a first part of the data contained in and/or of the metadata associated to the elements of the information block;
identifying the most probable value from the first set of values according to a given identification criterion based on the probability for the values of the first set;
associating a first block-metadatum to the information block, assigning the most probable value to a first value of the first block-metadatum, and storing the first value;
generating the electronic document specification comprising at least instructions for implementing the information block according to at least the first value.

2. Computer-implemented method according to claim 1, wherein the data contained in and/or the metadata associated to at least one element comprises information concerning dependencies between elements, said method further comprising the step of:
deriving the type of dependency between elements according to a dependency criterion and choosing and storing a value of at least a dependency-type definition from a given set of dependency-type definitions;
wherein the instructions for implementing the information block depend on the value of the dependency-type definition.

3. Computer-implemented method according to claim 1, wherein the instructions for implementing the information block comprise at least instructions to retrieve and/or to modify the information stored in the data-source.

4. Computer-implemented method according to claim 1, further comprising the steps of:
determining whether the information block fulfils a given block-tagging criterion, wherein the block-tagging criterion is based on at least the data contained in and/or on the metadata associated to the elements of at least a first subset of the information block;
if the information block fulfils the block-tagging criterion, associating a second block-metadatum to the information block, assigning a given block-tagging value to a second value of the second block-metadatum, and storing the second value;
wherein if the second block-metadatum is associated to the information block, the instructions for implementing the information block depend on the second value.

5. Computer-implemented method according to claim 1, further comprising the steps of:
determining whether the information block fulfils a given semantic-tagging criterion, wherein the semantic-tagging criterion is based at least on the first value, and/or on the comparison of the information block with given information blocks with known semantic;
if the information block fulfils at least the semantic-tagging criterion, associating a third block-metadatum to the information block, assigning a given semantic-tagging value to a third value of the third block-metadatum, and storing the third value;
wherein if the third block-metadatum is associated to the information block, the instructions for implementing the information block depend on the third value.

6. Computer-implemented method according to claim 1, wherein the instructions for implementing the information block are instructions readable by a mobile processor to generate a view of at least a second part of the data contained in the elements of the data-source.

7. Computer-implemented method according to claim 2, wherein the clustering of the elements into information blocks is obtained by performing either a divisive or an agglomerative hierarchical clustering analysis of the elements of the data-source, and optionally wherein the hierarchical clustering analysis is based on the block-building criterion and builds a hierarchy among the information blocks.

8. Computer-implemented method according to claim 7, wherein the choice of the value of the dependency-type definition is based at least on the hierarchy among the information blocks.

9. Computer-implemented method according to claim 1, wherein the probability for at least a value of the first set is computed by means of a given conditional probability distribution associated to the value, wherein optionally the conditional probability distribution is computed by means of a machine learning algorithm and/or by means of a discriminative model, in particular logistic regression, applied to a sample of known data-sources.

10. Computer-implemented method according to claim 2, wherein at least a part of the instructions for implementing the information block are obtained from a template chosen from a set of templates, said method further comprising the step of:
choosing the template from the set of templates according to a given template-selection criterion, wherein the template-selection criterion is based at least on the first value.

11. Computer-implemented method according to claim 10, wherein the template-selection criterion is based on at least the value of the dependency-type definition.

12. Computer-implemented method according to claim 10, wherein the choice of the template is performed by means of a machine learning algorithm.

13. A device configured to generate an electronic document specification, said device including storage means for storing at least an information block and associated block-metadata, and a processor connected to said storage means, said processor being configured to implement the steps of the method according to claim 1.

14. A computer program product comprising instruction modules which, when executed by a processor of a computer, cause the computer to implement the steps of the method according to claim 1.
